(19) United States
(12) Patent Application Publication
(10) Pub. No.: US 2026/0057578 A1
(43) Pub. Date: Feb. 26, 2026

(54) HARMONIZING VISUALIZATIONS FOR DATA EXPLORATION

(71) Applicant: Accentre Global Solutions Limited, Dublin (IE)

(72) Inventor: Maziyar BARAN POUYAN, Petaluma, CA (US)

(21) Appl. No.: 18/811,333

(22) Filed: Aug. 21, 2024

(51) Int. Cl. G06T 11/20

(52) U.S. Cl. CPC G06T 11/206

(57) ABSTRACT

Method, system, and computer-readable storage media for generating a data visualization. A plurality of algorithmic visualizations is received for a dataset. Based on the plurality of visualization matrices, a matrix is generated. Each visualization matrix of the plurality of visualization matrices corresponds with an algorithmic visualization of the plurality of algorithmic visualizations. A synthetic matrix is generated by randomly shuffling a plurality of values in each column of the matrix. A random forest classifier is trained to generate a random forest for distinguishing shuffled data of the synthetic matrix from unshuffled data of the matrix. Further, an ensemble visualization graph is generated using the random forest. From the ensemble visualization graph, an embedding vector corresponding to each sample of the dataset is extracted to generate an embedding matrix. Based upon the embedding matrix, the method includes generating the data visualization by harmonizing the plurality of algorithmic visualizations.

### TECHNICAL FIELD

Various embodiments described herein relate generally to computer-implemented method, computer system, and computer-readable media for harmonizing algorithmic visualizations for data exploration.

### BACKGROUND

Data visualization and dimension reduction have been extensively used for exploring larger and complex datasets in the fields of statistics and data science. The data visualization with the dimension reduction graphically represents the datasets in visualizations by reducing dimensions of the datasets, for example, reducing a three-dimensional (3D) dataset into a two-dimensional (2D) dataset. Such visualizations in a low-dimensional space enable users to obtain a comprehensive overview of the complex datasets with numerous dimensions and to gain an intuitive understanding for pattern recognition, trend analysis, insights derivation, and appropriate information extraction from the datasets.

### SUMMARY

Implementations of the present disclosure enable harmonization of multi-dimensional algorithmic visualizations for a dataset, by capturing non-linear relationships/dependencies among the algorithmic visualizations and by reducing memory complexity and run-time complexity.

In at least one example, the present disclosure provides a computer-implemented method for generating a data visualization. The method includes receiving a plurality of algorithmic visualizations for a dataset. The method includes generating a matrix based upon a plurality of visualization matrices. Each visualization matrix of the plurality of visualization matrices corresponds with an algorithmic visualization of the plurality of algorithmic visualizations. The method includes generating a synthetic matrix by randomly shuffling a plurality of values in each column of the matrix. The method includes training a random forest classifier to distinguish shuffled data of the synthetic matrix from unshuffled data of the matrix. The method includes generating an ensemble visualization graph. The ensemble visualization graph includes a plurality of samples and each sample of the plurality of samples is associated with a leaf node of a plurality of leaf nodes across all trees of a random forest. The method includes extracting, from the ensemble visualization graph, an embedding vector corresponding to each sample of the plurality of samples to generate an embedding matrix. Based upon the embedding matrix, the method includes generating the data visualization by harmonizing the plurality of algorithmic visualizations.

The present disclosure further provides a system for implementing the method provided herein. The present disclosure also provides a non-transitory computer-readable storage media (CRM) coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE FIGURES

Various embodiments in accordance with the present disclosure will be described with reference to the drawings, in which:

FIG. 1 depicts an example environment that may be used to execute implementations of the present disclosure.

FIG. 2 depicts an example architecture of a computing system for generation of a data visualization, in accordance with implementations of the present disclosure.

FIG. 3 depicts an example process flow of generating the data visualization, in accordance with implementations of the present disclosure.

FIGS. 4A-4E depict an example illustration of generating the data visualization by harmonizing different algorithmic visualizations of a dataset, in accordance with implementations of the present disclosure.

FIG. 5 is a flow diagram that presents an example computer-implemented method for generating the data visualization, in accordance with implementations of the present disclosure.

FIG. 6 illustrates a computer system that may be used to implement an example method for generating the data visualization, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the disclosure as set forth in the claims.

Data visualization is used for converting datasets into visualizations by reducing dimensions of the datasets into a low dimensional space. The visualizations aid in communicating or summarizing the datasets with accuracy, clarity, and efficiency. Therefore, the data visualization may be employed as an important hypothesis generation and analytical technique in the field of data-driven research to facilitate data exploration. For example, the data visualization is frequently employed in biomedical research to identify unexpected patterns and to formulate hypotheses in an unbiased manner in vast amounts of genomic and other associated datasets.

Over the past few decades, there has been a significant proliferation of multiple machine learning (ML) based data visualization/dimension reduction algorithms dedicated to the data visualizations. Examples of the data visualization algorithms may include Laplacian eigenmap, kernel principal component analysis (kPCA), t-Distributed Stochastic Neighbor Embedding (t-SNE), Uniform Manifold Approximation and Projection (UMAP), Isometric Mapping (ISOMAP), Local Linear Embedding (LLE), Sammon's mapping, Potential of Heat-diffusion for Affinity-based Trajectory Embedding (PHATE), and/or the like. Such data visualization methods may be used as cutting-edge techniques for creating the visualizations, which facilitate exploratory data analysis by uncovering data patterns in various research domains like computer vision, genetics, and molecular biology. Hereinafter, the visualizations generated by the data visualization algorithms are referenced as algorithmic visualizations.

The data visualization algorithms may have distinct characteristics. For example, the data visualization algorithms may have different tuning parameters or internal setting parameters and may generate the algorithmic visualizations for a dataset based on distinct logics and heuristics. Due to the distinct characteristics, the algorithmic visualizations generated by the data visualization algorithms may result in qualitatively diverse algorithmic visualizations that capture distinct features of the dataset. However, the distinct characteristics of the data visualization algorithms may pose a challenge in selecting a suitable and reliable data visualization algorithm for the dataset.

To illustrate, a data visualization algorithm like t-SNE may efficiently extract intrinsic structural information of the dataset compared to the data visualization algorithm like kPCA. The intrinsic structural information of the dataset may indicate clusters or population of datapoints/samples in the dataset. If the dataset includes gene expression data, then the intrinsic structural information of the dataset may indicate clusters or population of a specific cell. However, the t-SNE may fail to capture global/general representation of the dataset. For example, consider that there are two clusters of the dataset may be located close to each other in a low dimensional space and may not be located close to each other in a high dimensional space. In such a scenario, the t-SNE may fail to capture the global representation/clusters of the dataset in the high dimensional space.

In contrast to the t-SNE, the kPCA may capture the global representation of the dataset in the low dimensional space as well as in the high dimensional space. However, the kPCA may fail to capture the intrinsic structural information of the dataset.

In contrast to the kPCA, the data visualization algorithm like PHATE may capture the intrinsic structural information of the dataset along with extracting pseudo time trajectory of the dataset. However, the PHATE may only be able to extract the pseudo trajectory of the dataset in the low dimensional space. For example, if the dataset includes the gene expression data, the PHATE may be able to extract the pseudo time trajectory of longer or major cells only in the low dimensional space.

Therefore, selection of the data visualization algorithm for the dataset may require objective assessment and quantification of different algorithmic visualizations of the dataset, which may be time consuming and may require more computing resources. In addition, selection of an inappropriate data visualization algorithm for the dataset may have its influence on the resultant algorithmic visualization.

Further, the dataset including biomedical dataset like gene expression dataset may include multiple datapoints/samples (e.g., 10 thousand (K) to 15K samples) and may be high dimensional and noisy in nature. The algorithmic visualizations generated for the biomedical dataset may include distortions from underlying true structures, which may vary between the different algorithmic visualizations.

Therefore, harmonizing the different algorithmic visualizations by leveraging strengths of the respective data visualization algorithms and striving for a consensus among the data visualization algorithms may result in an enhanced ensemble data visualization of the dataset. The enhanced ensemble data visualization may maximize information capture from the dataset and minimize susceptibility to distortion.

In a known visualization harmonizing method such as Meta-Visualization, the data visualization is generated by harmonizing the different algorithmic visualizations based on quantitative measurements. A collection of different algorithmic visualizations (referenced hereinafter as candidate algorithmic visualizations) for a dataset may be obtained and each candidate algorithmic visualization may be summarized as normalized distance matrices among samples/datapoints of the respective dataset. Based on the normalized distance matrices, similarity matrices for the samples of the dataset may be computed. Each of the similarity matrices for each sample may be computed by comparing rows from the normalized distance matrices. Further, a first eigen vector of each of the similarity matrices may be extracted as eigen scores. A size of circles in the similarity matrices and the eigen scores reflect entry magnitudes, assuming non-negativity. Using the eigen scores, a meta-distance matrix may be constructed based on a weighted average of the rows in the normalized distance matrices. The meta-distance matrix may be used to generate the data visualization, which is an ensembled data visualization of the candidate algorithmic visualizations.

However, the visualization harmonizing method (e.g., Meta-Visualization) poses the following challenges, that hinder its applicability for visualizing huge/large datasets:
Memory complexity: Summarizing each candidate algorithmic visualization as the normalized distance matrices and computation of the similarity matrices involve evaluation and storage of the large dataset in a memory. For example, if the dataset is a biomedical dataset like gene expression data, a dataset matrix may include multiple rows and columns representing cells and genes for the cells, respectively. If the dataset includes 1 million cells, then the size of each of the normalized distance matrices may include 1 million times of 1 million cells. However, saving the normalized distance matrices of such a huge size may require a lot of memory space and further may be not possible in real-time scenarios.
Run-time complexity: Constructing the meta-distance matrix based on the normalized distance matrices of the huge size may be very much time consuming.
Usage of linear methods: The meta-distance matrix may be constructed by applying linear methods on the normalized distance matrices. With the linear methods, non-linear relationships/dependencies among the different algorithmic visualizations may not be captured.

Implementations of the present disclosure enable harmonizing of multiple algorithmic visualizations by capturing non-linear relationships/dependency among different algorithmic visualizations and without requiring any calculation of pair-wised distance matrices. Therefore, the algorithmic visualizations corresponding to large datasets may be efficiently harmonized with reduced memory consumption and without run time complexity.

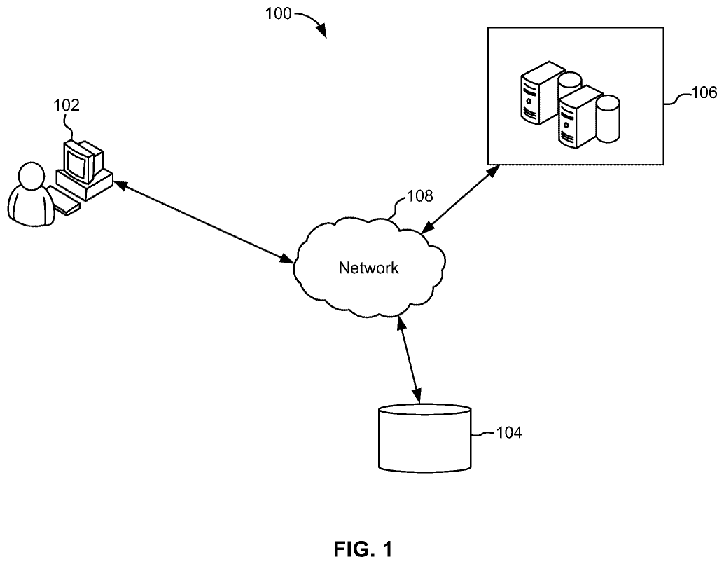

FIG. 1 depicts an example environment 100 that may be used to execute implementations of the present disclosure. In some examples, the example environment 100 enables generation of a data visualization by harmonizing different algorithmic visualizations.

As depicted in FIG. 1, the example environment 100 includes a computing device 102, a database 104, and a computing system 106. The components 102-106 of the environment 100 may be communicated with each other using a network 108. In some examples, the network 108 may include, but is not limited to, a Local Area Network (LAN), a Wide Area Network (WAN), the Internet, or a combination thereof, and communicatively connects the computing system 106 with the computing device 102 and the database 104. In some examples, the network 108 may be accessed over a wired and/or a wireless communication link.

For simplicity, a single computing device 102 is depicted in FIG. 1. However, it is understood that the example environment 100 may include one or more computing devices. Examples of the computing device 102 may include a desktop, smartphones, laptops, a tablet, voice-enabled devices, a digital camera, and/or the like. It is contemplated that the implementations of the present disclosure may be realized with any appropriate type of computing device.

The computing device 102 may receive datasets from different data sources (not shown in FIG. 1). Each of the datasets may have multiple dimensions. In some examples, the datasets may include biomedical data like a single cell gene expression dataset. In some examples, the datasets may include datasets related to ecological, financial, actuarial, oncology, and healthcare applications. As would be understood, the present disclosure may include the datasets related to any applications that involve complex relationships amongst associated samples and/or extensive dimensionality.

In some examples, the computing device 102 may generate algorithmic visualizations for each of the datasets. Each of the algorithmic visualizations may represent a respective dataset in a form of visualization (e.g., a graph, a chart, a map, and/or the like) by reducing a dimension of the respective dataset into a low dimensional space. Further, each of the algorithmic visualizations may disclose data structure and patterns of samples/datapoints in the respective dataset.

The computing device 102 may generate the algorithmic visualizations using data visualization algorithms. As would be understood, each of the data visualization algorithms may include dimension reduction techniques or a dimension reduction algorithm itself. Examples of the data visualization algorithms may include, but not limited to, Laplacian eigenmap, kPCA, t-SNE, UMAP, ISOMAP, LLE, Sammon's mapping, PHATE, and/or the like. The computing device 102 may store the algorithmic visualizations generated for each of the datasets in the database 104.

In some other examples, the computing device 102 may provide the datasets to the computing system 106 and/or any external entities (not shown in FIG. 1) for generating the algorithmic visualizations for each of the datasets using the data visualization algorithms. The algorithmic visualizations generated by the computing system 106 and/or external entities may be stored in the database 104.

In some other examples, the computing device 102 may provide the datasets to the computing system 106 and receive data visualizations corresponding to the datasets from the computing system 106. Each of the data visualizations may be generated by harmonizing the algorithmic visualizations corresponding to the respective dataset, which is described in detail along with the computing system 106. The data visualizations corresponding to the datasets may be stored in the database 104.

In some examples, the computing system 106 may be implemented as an on-premises system. In some other examples, the computing system 106 may be implemented as an off-premises system (for example, a cloud or an on-demand system). Additionally, or alternatively, the computing system 106 may be implemented in a cloud environment. For simplicity, the computing system 106 depicted in FIG. 1 may be a cloud environment that is intended to represent various forms of servers including a web server, an application server, a proxy server, a network server, a server pool, and/or the like.

In some examples, the computing system 106 may receive the dataset(s) and the associated algorithmic visualizations for the respective dataset from the computing device 102 and/or the database 104 for a respective data visualization. In some other examples, the computing system 106 may receive the dataset from the computing device 102 for the respective data visualization. In such a scenario, the computing system 106 may generate the algorithmic visualizations for the dataset using the data visualization algorithms. Alternatively, the computing system 106 may receive the algorithmic visualizations for the dataset from the database 104 (if already available) and/or the external entities.

In accordance with implementations of the present disclosure, the computing system 106 may generate the data visualization for the dataset. The data visualization may be an enhanced ensemble data visualization generated by harmonizing the algorithmic visualizations corresponding to the dataset.

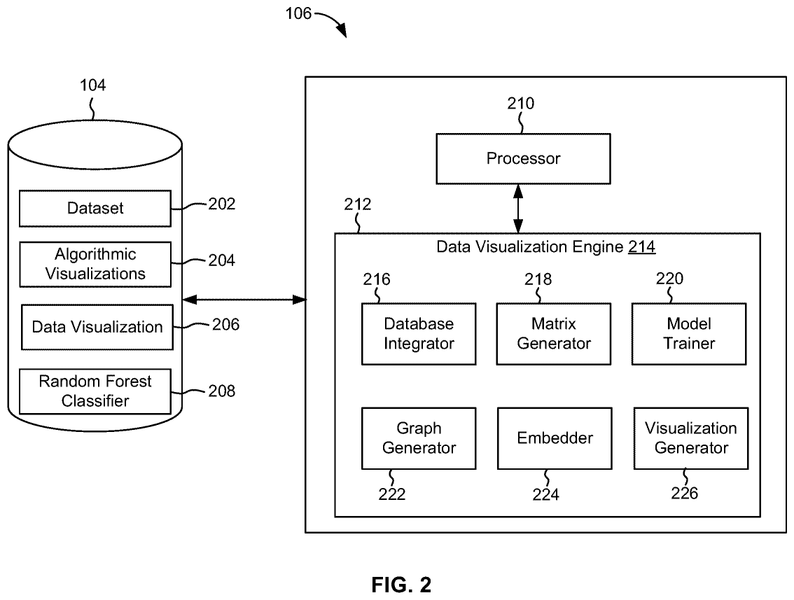

Various examples depicting generation of the data visualization by harmonizing the algorithmic visualizations of the respective dataset are described in detail in conjunction with FIGS. 2-6.

FIG. 2 depicts an example architecture of the computing system 106 for generation of the data visualization, in accordance with implementations of the present disclosure. As depicted in FIG. 2, the computing system 106 may be communicatively coupled to the database 104 through the network 108 (depicted in FIG. 1).

The database 104 may act as repository for storing a dataset 202, algorithmic visualizations 204 for the dataset 202, and data visualization 206 for the respective dataset 202. For simplicity, the database 104 depicted in FIG. 2 includes the single dataset 202 and the associated algorithmic visualizations 204 and data visualization 206. As would be understood, the database 104 may store one or more datasets, algorithmic visualizations for each of the one or more datasets, and one or more data visualizations for the respective one or more datasets.

The dataset 202 may be stored in a form of dataset matrix in the database 104. The dataset matrix may include rows and columns for each of the rows. The rows and the columns of the dataset matrix may indicate samples/datapoints of the dataset 202. In some examples, the dataset(s) 202 may include a single cell gene expression data. The single cell gene expression data may be stored in the database 104 in a form of gene expression matrix (an example of the dataset matrix). The gene expression matrix includes data entries representing the single cell gene expression data. The gene expression matrix may list one or more cells and one or more genes associated with each of the one or more cells. The cells and the genes may be the samples of the dataset 202 corresponding to the single cell gene expression data. In some other examples, the dataset 202 may include a healthcare dataset, a financial dataset, an ecological dataset, an actuarial dataset, and/or the like.

In some examples, the algorithmic visualizations 204 of the dataset 202 may indicate multiple visualizations of the dataset 202 generated using the multiple data visualization algorithms. Examples of the data visualization algorithms may include kPCA, t-SNE, UMAP, LLE, Sammon's mapping, PHATE, and/or the like.

In some examples, the data visualization 206 may be an enhanced ensemble data visualization generated for the dataset 202. The data visualization 206 may include harmonization of the algorithmic visualizations 204 corresponding to the dataset 202.

The database 104 may also store a random forest classifier 208. As would be understood, the random forest classifier 208 may be stored in any other separate database. The random forest classifier 208 may be a supervised machine learning (ML) model constructed from decision tree methods. The random forest classifier 208 may be trained to generate a random forest for a given dataset. The random forest may include multiple decision trees. A decision tree may form a tree-like structure including decision nodes, leaf nodes, and a root node. The decision nodes may be connected to the root node through branches. The decision nodes may also be connected to other decision nodes through branches. The given dataset may be divided into the branches, which may further segregate into other branches. Such a dividing process of the given dataset may be continued until at least one leaf node is attained for each of the decision nodes. The random forest classifier 208 may be used for capturing non-linear relationships/dependencies among the algorithmic visualizations 204, while generating the data visualization 206 for the dataset 202, which is described in detail below in conjunction with components of the computing system 106. It is contemplated that the implementations of the present disclosure may also use an extreme Gradient Boosting (XBoost) classifier (e.g., a tree-based ML classifier) for capturing the non-linear relationships/dependencies among the algorithmic visualizations 204.

The computing system 106 includes a processor 210 and a memory 212. The processor 210 may include one or more processors 210. Examples of the processor 210 may include but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. The processor 210 may be communicatively coupled with the memory 212. Further, the processor 210 may be configured to execute instructions (also referenced herein as computer-readable instructions) for performing operations according to the present disclosure. The memory 212 may be non-transitory or non-volatile medium, such as a magnetic disk or solid-state non-volatile memory or volatile medium such as Random Access Memory (RAM), and/or the like.

Further, the computing system 106 includes a data visualization engine 214, as depicted in FIG. 2. The data visualization engine 214 may be stored in the memory 212 and provided as a downloadable library including the instructions. The data visualization engine 214 may be configured to generate the data visualization 206 for the dataset 202.

The data visualization engine 214 includes a database integrator 216, a matrix generator 218, a model trainer 220, a graph generator 222, embedder 224, and visualization generator 226.

The database integrator 216 receives the algorithmic visualizations 204 for the dataset 202 from the database 104. In some examples, each of the algorithmic visualizations 204 may be represented in a form of graphs. Further, each of the algorithmic visualizations 204 may include a multi-dimensional algorithmic visualization. In some examples, one or more of the algorithmic visualizations 204 may include a two-dimensional (2D) algorithmic visualization. In some other examples, one or more of the algorithmic visualizations 204 may include a three-dimensional (3D) algorithmic visualization. The database integrator 216 may provide the algorithmic visualizations 204 of the dataset 202 to the matrix generator 218.

The matrix generator 218 generates a matrix for the algorithmic visualizations 204 of the dataset 202. For generating the matrix, the matrix generator 218 may generate visualization matrices for the respective algorithmic visualizations 204. In some examples, each of the visualization matrices may be a tabular form of the respective algorithmic visualization. Each of the visualization matrices may include data entries represented in rows and columns. Based on the visualization matrices, the matrix generator 218 may generate the matrix. The matrix generator 218 may generate the matrix by juxtaposing the visualization matrices. For example, the matrix generator 218 may generate the matrix by arranging the visualization matrices next to each other.

Once the matrix is generated, the matrix generator 218 generates a synthetic matrix (also referenced herein as synthetic dataset). The synthetic matrix may be generated by randomly shuffling values in each column of the matrix independently. In some examples, the values in each column of the matrix may be randomly shuffled with any other column of the matrix. Therefore, the synthetic matrix may include the shuffled data/samples and the matrix may include the unshuffled data/samples.

Upon generating the matrix and the associated synthetic matrix, the matrix generator 218 may assign unique labels for all the rows of the matrix and the synthetic matrix. The matrix generator 218 may assign the unique labels for all the rows of the matrix and the synthetic matrix by creating an additional column (also referenced herein as label column) in the matrix and the synthetic matrix. Therefore, each of the matrix and the synthetic matrix may include one or more rows, one or more columns for each of the one or more rows, and a label column indicating one or more labels for the respective one or more rows. The matrix generator 218 may provide the matrix corresponding to the algorithmic visualizations 204 and the associated synthetic matrix to the model trainer 220.

The model trainer 220 trains the random forest classifier 208 to generate a random forest based on the matrix and the associated synthetic matrix. The random forest may be used to distinguish shuffled data of the synthetic matrix from unshuffled data of the matrix. Also, with the random forest, non-linear relationships/dependencies among the samples (e.g., corresponding to the rows of the matrix) of the dataset 202 found across the algorithmic visualizations 204 may be derived. Thereby, the non-linear relationships/dependencies among the algorithmic visualizations 204 may be derived.

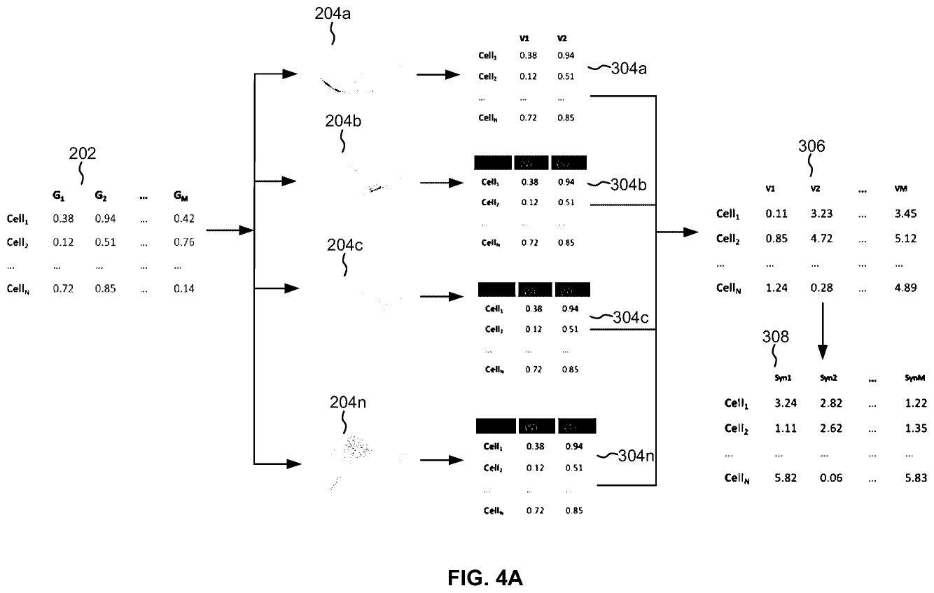

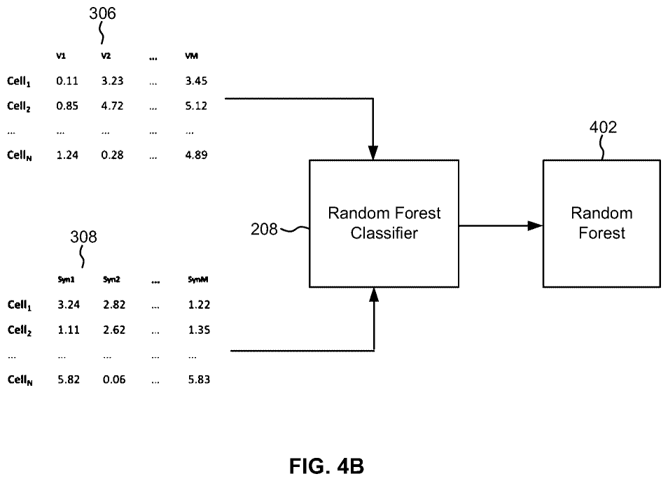

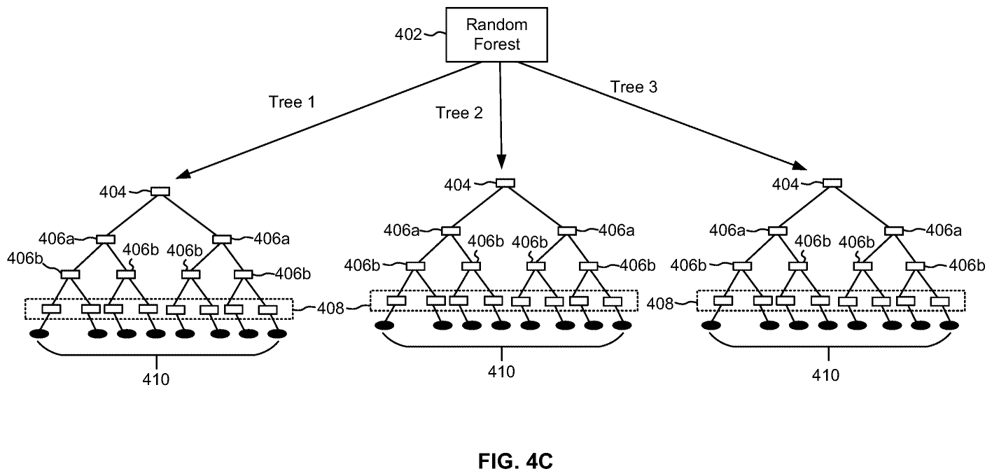

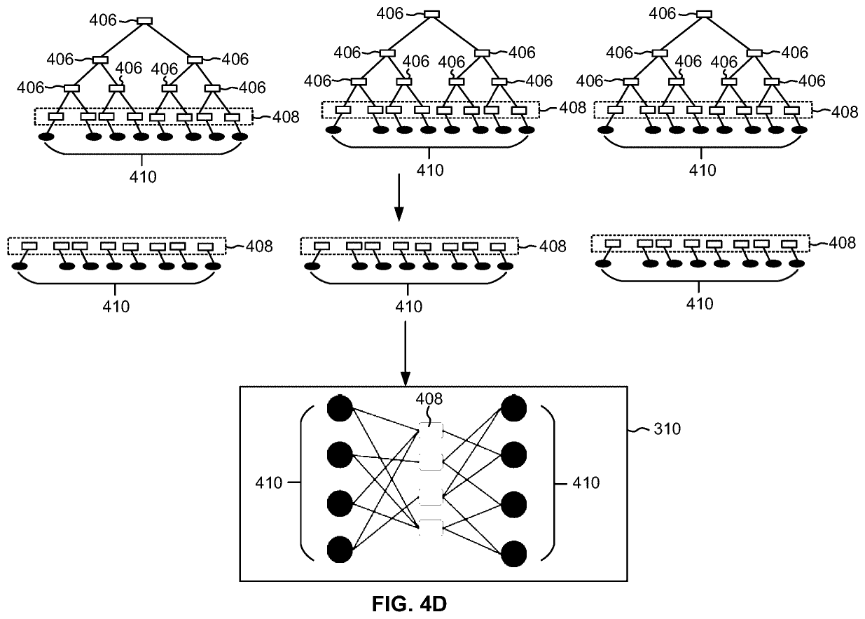

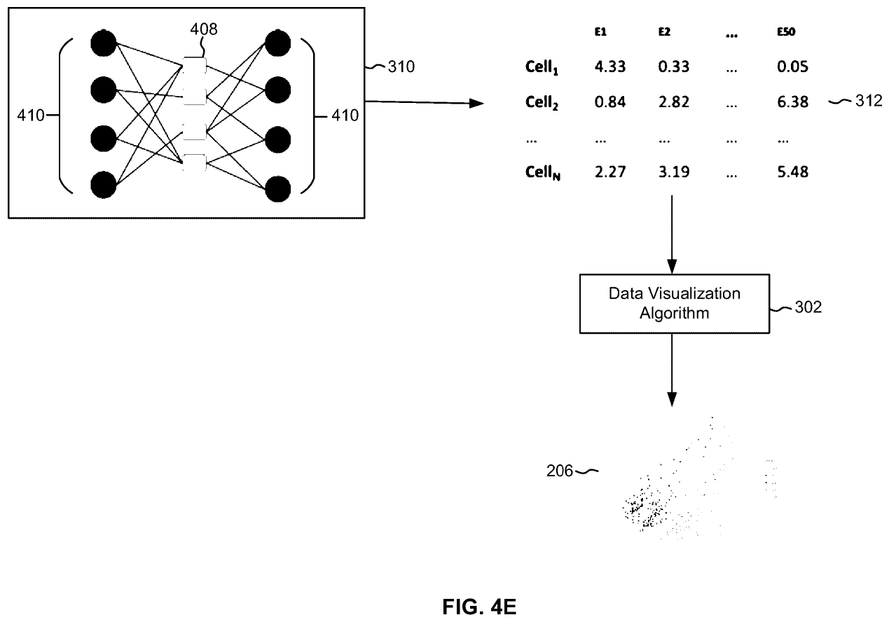

The random forest may include one or more trees. Each of the one or more trees may be formed on the shuffled data of the synthetic matrix and the unshuffled data of the matrix. Each of the one or more trees may include a root node, one or more decision nodes, and one or more leaf nodes for each of the one or more decision nodes. The root node may be connected to the one or more decision nodes through branches. The one or more decision nodes may be formed by splitting the samples of the matrix and the synthetic matrix until forming one or more nodes for each of the one or more decision nodes that do not split further. The one or more nodes that do not split further may be the one or more leaf nodes formed for each of the one or more decision nodes. Each of the one or more leaf nodes may be connected to one or more respective last level of nodes (also referenced herein as circular nodes), which represent the one or more samples corresponding to the one or more rows of the matrix or the synthetic matrix. Further, a proximity between the leaf nodes may indicate a semantic proximity of the respective samples (corresponding to the rows of the matrix) that may be comparable across the algorithmic visualizations 204. For example, the samples placed in common or closer leaf nodes throughput the random forest if their proximities across the algorithmic visualizations 204 are generally comparable. The random forest generated for distinguishing the shuffled data of the synthetic matrix and the unshuffled data of the matrix is described in detail in conjunction with FIG. 4C. The model trainer 220 may provide the random forest to the graph generator 222.

The graph generator 222 generates an ensemble visualization graph (EVG) based on the random forest tree generated using the shuffled data of the synthetic matrix and the unshuffled data of the matrix. The EVG may be a universal graph generated by connecting the samples of the last level of nodes to the leaf nodes of all the one or more trees of the random forest and removing other nodes (e.g., the decision nodes and the root node) of all the one or more tress of the random forest. The graph generator 222 further removes the samples corresponding to the shuffled data of the synthetic matrix from the EVG. Thereby, the EVG may be generated by considering the unshuffled data of the matrix and discarding the unshuffled data of the synthetic matrix. The graph generator 222 may provide the EVG with the unshuffled data/samples of the matrix to the embedder 224.

The embedder 224 extracts an embedding vector corresponding to each sample from the EVG. The embedding vector may represent a vector representation of the EVG. In some examples, the embedder 224 may extract the embedding vector by applying graph node embedding techniques on the EVG. Examples of the graph node embedding techniques may include Node2Vec, Fast Random Projection, NodePiece, LINE techniques, and/or the like. The embedder 224 further uses the embedding vector to generate an embedding matrix. The embedder 224 may provide the embedding matrix to the visualization generator 226.

The visualization generator 226 generates the data visualization 206 based on the embedding matrix. The visualization generator 226 may use any of the data visualization algorithms for generating the data visualization 206 for the embedding matrix. The data visualization 206 may be the enhanced ensemble graph depicting harmonization of the algorithmic visualizations 204. The data visualization 206 may provide information about all the samples of the dataset 202 present across the algorithmic visualizations 204.

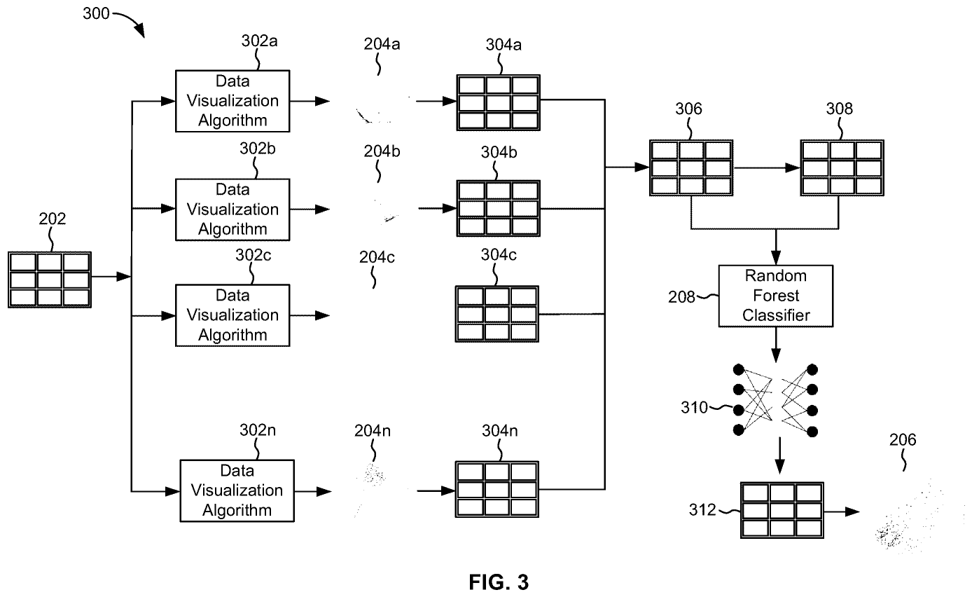

FIG. 3 depicts an example process flow 300 of generating the data visualization 206 harmonizing the algorithmic visualizations 204, in accordance with implementations of the present disclosure.

As depicted in FIG. 3, the computing system 106 receives the dataset 202 of having dimensions in a high dimensional space. Upon receiving the dataset 202, the computing system 106 uses the data visualization algorithms 302a-302n to generate the respective algorithmic visualizations 204a-204n (collectively referenced herein as the algorithmic visualizations 204). In some examples, the computing system 106 may select the data visualization algorithms 302a-302n based on requirements for the generation of the respective algorithmic visualization. The requirements may indicate what needs to be explored from the dataset 202, tunable hyperparameter values to be tuned for the algorithmic visualizations 204, and/or the like.

The data visualization algorithms 302a-302n may include kPCA, t-SNE, UMAP, LLE, Sammon's mapping, PHATE, and/or the like (which are already known and not further described herein). The algorithmic visualizations 204a-204n may represent visualizations of the dataset 202 by reducing the dimensions of the dataset 202 into a low dimensional space. As would be understood, the computing system 106 may receive the dataset 202 as well as the corresponding algorithmic visualizations 204a-204b from the computing device 102, or the database 104, or the external entities.

Upon generating the algorithmic visualizations 204a-204n, the computing system 106 generates the visualization matrices/tabular forms 304a-304n for the respective algorithmic visualizations 204a-204n. Each of the visualization matrices 304a-304n may include the samples of the dataset 202 in a form of the rows and the columns. Further, the computing system 106 generates the matrix 306 by integrating all of the visualization matrices 304a-304n corresponding to the algorithmic visualizations 204a-204n.

Once the matrix 306 is generated, the computing system 106 generates the synthetic matrix 308 by randomly shuffling values of each column of the matrix 306 independently. Further, the computing system 106 may add the labels for each row of the matrix 306 as well as the synthetic matrix 308.

Further, the computing system 106 integrates the matrix 306 and the synthetic matrix 308 and uses such an integration to train the random forest classifier 208. The random forest classifier 208 may be trained to generate the random forest based on the unshuffled data/samples of the matrix 306 and the shuffled data/samples of the synthetic matrix 308. Further, the labels of the matrix 306 and the synthetic matrix 308 may aid the random forest classifier 208 in generating the random forest, as the random forest classifier 208 operates on the supervised learning method.

The random forest may include the trees. Each of the trees may include the root node, the decision nodes, and the leaf nodes. The shuffled data of the synthetic matrix 308 and the unshuffled data of the matrix 306 may be distributed across the nodes of each of the trees. To illustrate, the leaf nodes/layer 2 may be connected to the samples corresponding to the rows of the matrix 306 and the synthetic matrix 308. Specifically, the leaf nodes may be connected to the last level of nodes on which all the rows of the matrix 306 and the synthetic matrix 308 may be landed.

Using the random forest, the computing system 106 derives the EVG 310 by considering the leaf nodes and discarding the decision nodes and root node of the trees. Therefore, the EVG 310 may include the connected samples corresponding to the rows of the matrix 306 and the synthetic matrix 308. Further, the computing system 106 may remove the samples corresponding to the rows and the columns of the synthetic matrix 308 from the EVG 310. Therefore, the EVG 310 may disclose the non-linear relationships/dependencies among the samples (e.g., corresponding to rows of the matrix 306) found across the algorithmic visualizations 204a-204n.

Once the EVG 310 is derived, the computing system 106 generates the embedding matrix 312 corresponding to the EVG 310. The computing system 106 uses any of the data visualization algorithms 302a-302n to generate the data visualization 206 for the dataset 202 based on the embedding matrix 312. Therefore, the data visualization 206 may be generated by harmonizing the algorithmic visualizations 204a-204n based on their non-linear dependencies.

An example illustration of generating the data visualization 206 for the dataset 202 is described in detail below in conjunction with FIGS. 4A-4E.

FIGS. 4A-4E depict an example illustration of generating the data visualization 206 by harmonizing the different algorithmic visualizations 204a-204n of the dataset 202, in accordance with implementations of the present disclosure.

As depicted in FIG. 4A, the computing system 106 receives the dataset 202. The dataset 202 includes a single cell gene expression data. While implementations of the present disclosure are described in further detail herein with non-limiting reference to the single cell gene expression data as the dataset 202, it is contemplated that implementations of the present disclosure may be realized using any other dataset related to financial, ecological, and healthcare applications.

The dataset 202 corresponding to the single cell gene expression data may be high-dimensional including a large number of genes, for example, 15 thousand (K)-23K genes. The dataset 202 corresponding to the single cell gene expression data may be represented in its tabular/matrix form including, for example, ‘N’ rows and ‘M’ columns. For example, the ‘N’ rows may indicate a ‘N’ number of cells and the ‘M’ columns may indicate a ‘M’ number of genes associated with each of the ‘N’ number of cells. Thereby, a gene expression may be tabulated into the table/matrix with respect to attributes of the genes.

The computing system 106 generates the algorithmic visualizations 204a-204n for the dataset 202 corresponding to the single cell gene expression data. The algorithmic visualizations 204a-204n may be generated using the respective data visualization algorithms 302a-302n. In an example herein, each of the algorithmic visualizations 204a-204n may illustrate samples (e.g., the cells and the genes corresponding to the rows and the columns) of the dataset 202 in a 2D dimensional space.

The computing system 106 further generates the visualization matrices 304a-304n for the respective algorithmic visualizations 204a-204n. For example, as depicted in FIG. 4A, each of the visualization matrices 304a-304n may include ‘N’ rows indicating the ‘N’ number of cells and two columns ‘V1’ and ‘V2’ for each of the ‘N’ number of cells. Further, the computing system 106 generates the matrix 306 corresponding to the visualization matrices 304a-304n. The matrix 306 may be generated by juxtaposing the visualization matrices 304a-304n. The matrix 306 may include ‘N’ rows indicating the ‘N’ number of cells and a ‘(V₁, V₂ . . . V_{M})’ number of columns for each of the ‘N’ rows.

Once the matrix 306 is generated, the computing system 106 generates the synthetic matrix 308 by randomly shuffling the columns of the matrix 306. For example, values of columns ‘V₁’, ‘V₂’, and ‘V₃’ may be shuffled with values of columns ‘V₄’, ‘V₅’, and ‘Ve’ to generate new columns like ‘Syn₁’, ‘Syn₂’ and ‘Syn₃’, respectively. Similarly, values of the other columns may be randomly shuffled. Therefore, the computing system 106 may shuffle the ‘(V₁, V₂ . . . V_{M})’ number of columns randomly to generate a new ‘(Syn₁, Syn₂ . . . Syn_{M})’ number of columns. Due to which, the synthetic matrix 308 may include ‘N’ number of rows indicating ‘N’ number of cells and the ‘(Syn₁, Syn₂ . . . Syn_{M})’ number of columns. The ‘N’ number of rows in the synthetic matrix may be 2*‘N’ number of rows in the matrix 306.

The computing system 106 also adds additional label columns, for example, a column A and a column B, for the rows of the matrix 306 and the rows of the synthetic matrix 308, respectively (not depicted in FIG. 4A). The label columns may include any random values, for example, ‘1’s, and ‘0’s. The matrix 306 and the synthetic matrix 308 may be used for generating the random forest using the random forest classifier 208, which is described in detail along with FIG. 4B.

As depicted in FIG. 4B, the computing system 106 trains the random forest classifier 208 based on the matrix 306 and the synthetic matrix 308. The random forest classifier 208 may be trained in accordance with a supervised learning method. In some examples, the labels columns of the matrix 306 and the synthetic matrix 308 may provide the labels for training of the random forest classifier 208 in accordance with a supervised learning method.

The trained random forest classifier 208 may generate the random forest 402 based on the matrix 306 and the synthetic matrix 308. In some examples, utilizing the synthetic matrix 308 for training of the random forest classifier 208 may help in generating the random forest 402 by efficiently deriving the non-linear relationships or non-linear dependencies among the samples (corresponding to rows of the matrix 306) found across the algorithmic visualizations 204a-204n. For example, with the shuffled data in the synthetic matrix 308, dependencies among the rows found across the algorithmic visualizations 204a-204n may be removed. Removal of dependencies using the synthetic matrix 308 may result in generation of the random forest 402 by deriving the non-linear dependencies among the rows found across the algorithmic visualizations 204a-204n. The random forest 402 generated using the trained random forest classifier 208 is depicted in detail along with FIG. 4C.

As depicted in FIG. 4C, the random forest 402 includes multiple trees. For simplicity, three trees (tree 1, tree 2, and tree 3) are depicted in FIG. 4C, however it is understood that the random forest 402 may include any number of trees. Each of the trees may include a root node 404, and decision nodes. The decision nodes may be connected to the root node 404 by branches (e.g., straight lines). The decision nodes directly connected to the root node 404 are referenced herein as decision nodes 406a, as depicted in FIG. 4C. The decision nodes may also be connected to other decision nodes/leaf nodes by branches as well. The decision nodes connected to the decision nodes 406a (that directly connected to the root node 404) are referenced herein as decision nodes 406b, as depicted in FIG. 4C.

At each decision node 406a connected directly to the root node 404, another sample (e.g., a gene) may be selected to the next decision node 406b connected by the branch to the decision node 406a that is closest to the root node 404. For example, the decision nodes 406a may be selected based on feature importance. The selection may be made during the training phase of Random Forest based on feature importance. Following down the line of branches from the root node 404, each subsequent decision node 406a-406b is selected in this fashion until there are one or more nodes that do not split. The nodes that do not split may be referred to as leaf nodes 408. The leaf nodes 408 may be further connected to a last level of nodes 410 (depicted as circular nodes in FIG. 4C). The last level of nodes 410 connected to the leaf nodes may represent the samples corresponding to the rows of the matrix 306. Thereby, the last level of nodes 410 may represent individual cells (e.g., C1, C2, C3 . . . ). For example, first and second last level of nodes 410 connected to first and second leaf node of the leaf nodes 408 may respectively represent cells 3 and 4 corresponding to rows 3 and 4 of the matrix 306. Therefore, all the rows of the matrix 306 and the synthetic matrix 308 may be landed in the last level of nodes 410 connected to the leaf nodes 408.

The random forest 402 (as described above) may be used to generate the EVG 310, which is described in detail along with FIG. 4D.

As depicted in FIG. 4D, upon obtaining the random forest 402, the computing system 106 identifies the leaf nodes across all the trees of the random forest 402, as the leaf nodes are super nodes connecting to the most similar samples/cells (corresponding to the rows of the matrix 306) to each other. For example, two cells may be placed in common or closer leaf nodes throughout the random forest 402 if their gene-gene interactions are generally comparable. Therefore, based on the identified leaf nodes, the computing system 106 generates the EVG 310.

The EVG 310 may be generated by connecting the cells/samples landed in the last levels of nodes 410 to their relevant leaf nodes 408 across all the trees of the random forest 402 and eliminating/discarding the rest of the trees. The generated EVG 310 may model how each of the rows found across the algorithmic visualizations 204 relates to the others. The EVG 310 may be used to generate the embedding matrix 312, which is described in FIG. 4E.

As depicted in FIG. 4E, the computing system 106 may generate the embedding matrix 312 by extracting the embedding vector from the EVG 310. The embedding vector may correspond to the samples (e.g., the rows and the columns) of the dataset 202 derived from the EVG 310. Once the embedding matrix 312 is generated, the computing system 106 may use the data visualization algorithm 302 (e.g., may include any of the data visualization algorithms 302a-302n) to generate the data visualization 206 for the dataset 202 based on the embedding matrix 312. The data visualization 206 may be a universal visualization for any selection, combination/harmonization, and implementation of the algorithmic visualizations 204 generated for the dataset 202 using the respective data visualization algorithms 302a-302n.

The data visualization 206 generated for the dataset 202 corresponding to the single cell gene expression data may be useful in downstream process. For example, the data visualization 206 may be used to extract complex non-linear gene interactions for a single cell, conditions of cells, local and global properties associated with the samples (e.g., genes/cells) of the dataset 202, and/or the like.

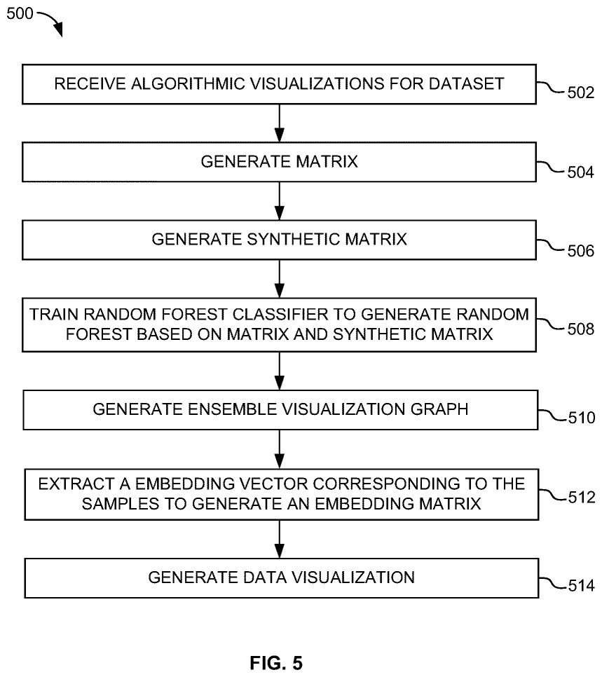

FIG. 5 is a flow diagram 500 that presents an example computer-implemented method 500 for generating the data visualization 206 (depicted in FIG. 2), in accordance with implementations of the present disclosure. In some implementations, the method 500 may be executed within the computing system 106 and by one or more processors 210 (depicted in FIG. 2) using modules of the memory 212 (depicted in FIG. 2).

The method includes receiving 502 the algorithmic visualizations 204 for the dataset 202. The dataset 202 and the algorithmic visualizations 204 may be received from the database 104, as depicted in FIG. 5. In some examples, the dataset may include a single cell gene expression dataset.

The method includes generating 504 the matrix 306 (depicted in FIG. 3) based upon the visualization matrices 304a-304n (depicted in FIG. 3). The visualization matrices 304a-304n may correspond to the algorithmic visualizations 204 (e.g., including the algorithmic visualizations 204a-204n, as depicted in FIG. 3) of the dataset 202. In some examples, each of the algorithmic visualizations 204 may include a 2D algorithmic visualization. In some other examples, each of the algorithmic visualizations 204 may include a 3D algorithmic visualization. As would be understood, each of the algorithmic visualizations 204 may include a multi-dimensional algorithmic visualization. The matrix 306 may be generated by juxtaposing the visualization matrices 304a-304n.

The method further includes generating 506 the synthetic matrix 308 (show in FIG. 3) by randomly shuffling the values in each column of the matrix 306. Generating the matrix 306 and the synthetic matrix 308 are described in detail in conjunction with FIGS. 3 and 4A, therefore repeated description is omitted herein for sake of brevity.

Upon generating the matrix 306 and the synthetic matrix 308, the method includes training 508 the random forest classifier 208 (shown in FIG. 2) to generate the random forest 402 (shown in FIG. 4B). The random forest classifier 208 may be trained based on the matrix 306 and the synthetic matrix 308 to generate the random forest 402, which may be used to distinguish the shuffled data of the synthetic matrix 308 from the unshuffled data of the matrix 306. The random forest 402 is described in detail in conjunction with FIGS. 4B and 4C, therefore repeated description is omitted herein for sake of brevity.

The method further includes generating 510 the EVG 310. The EVG 310 may be generated by connecting the samples (e.g., corresponding to the rows of the matrix 306) to the respective leaf nodes that spread across all the trees of the random forest 402 and discarding the remaining parts/nodes of the random forest 402. Further, the method includes removing the samples corresponding to the rows of the synthetic matrix 308 from the EVG 310. Generation of the EVG 310 is described in conjunction with FIG. 4D, therefore, repeated description is omitted herein.

From the EVG 310, the method includes extracting 512 the embedding vector corresponding to the samples to generate the embedding matrix 312 (depicted in FIG. 4E). In some examples, a graph node embedding (also referenced herein as network representation learning) may be applied on the EVG 310 to obtain the embedding vector.

Based on the embedding matrix, the method includes generating 514 the data visualization 206 harmonizing the algorithmic visualizations.

Implementations of the present disclosure provide technical solutions to multiple technical problems that arise in the context of data visualizations. The proposed methodology herein generates an enhanced ensemble data visualization corresponding to multiple algorithmic visualizations. The enhanced ensemble data visualization may maximize information capture and minimize susceptibility to data distortions.

Implementations of the present disclosure generate the enhanced ensemble data visualization by not only combing/harmonizing multiple algorithmic visualizations but also eliminating a requirement for calculation and storage of pair-wised distance matrices between samples of datasets. Due to which, memory complexity and run-time complexity may be reduced.

Implementations of the present disclosure also generate the enhanced ensemble data visualization by involving a random tree classifier/XBoost classifier, which may enable capturing of non-linear relationships/dependencies among the multiple algorithmic visualizations.

Therefore, implementations of the present disclosure enable generation of the enhanced ensemble data visualizations for larger datasets (even including biomedical datasets of having dimensions in a high dimensional space) by optimizing use of technical resources (processors, memory, bandwidth), which may improve functioning of the computing system 106.

Implementations of the present disclosure further perform an evaluation on the different algorithmic visualizations 204 of the dataset 202 to evaluate preservation of an underlying structure in the different algorithmic visualizations 204 of the dataset 202. Thereby, ensuring intrinsic structure integrity of the enhanced ensemble data visualization 206 generated for the dataset 202. In an example, the evaluation may be performed using a local concordance metric. The local concordance metric may measure a similarity between normalized distances of the different algorithmic visualizations 204 and the true underlying structure of the dataset 202. A high value of the local concordance metric may indicate that the respective algorithmic visualization 204 preserves intrinsic structure of the dataset 202 more accurately. In an example, the local concordance metric ‘sᵢ’ for a sample ‘i’ may be defined as:

$${s}_{i} = ( {( {\hat{{P}_{i :}}}^{( 1 )} )}^{T} {\hat{{P}_{i :}}}^{( * )} , {( {\hat{{P}_{i :}}}^{( 2 )} )}^{T} {\hat{{P}_{i :}}}^{( * )} , … … {( {\hat{{P}_{i :}}}^{( K )} )}^{T} {\hat{{P}_{i :}}}^{( * )} ) ∈ {R}^{K}$$

wherein,

$$‘ {\hat{{P}_{i}}}^{( K )} ’$$

indicates a normalized distance vector of the sample ‘i’ in the k^{th} algorithmic visualization,

$$‘ {\hat{{P}_{i}}}^{( * )} ’$$

indicates a normalized distance vector of the sample ‘i’ in the underlying true structure, and ‘K’ indicates a number of algorithmic visualizations.

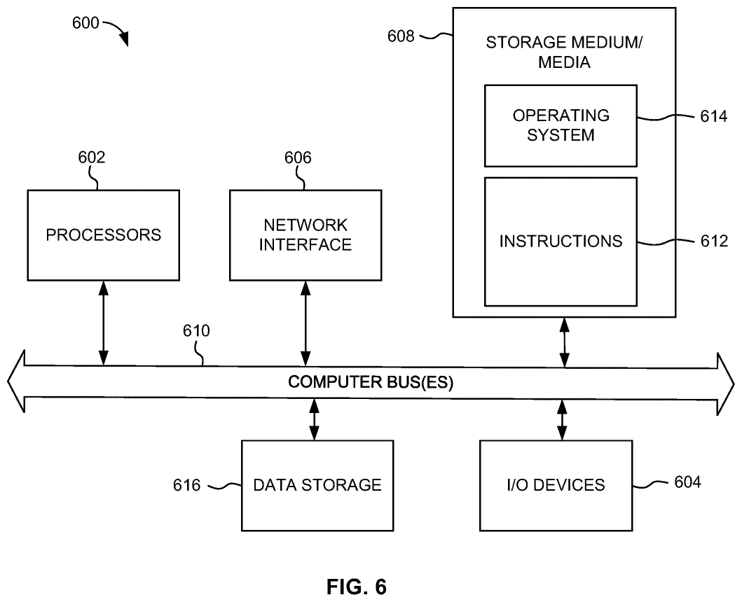

FIG. 6 illustrates a computer system 600 that may be used to implement the computer-implemented method 500. More particularly, computing machines such as desktops, laptops, smartphones, tablets, and wearables which may be used to generate the data visualization. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 802.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the computing system 600.

The computing system 600 may be implemented as software stored on a non-transitory processor-readable medium and executed by the processor(s) 602. For example, the computer-readable medium 608 may store an operating system 614, such as MAC OS, MS WINDOWS, UNIX, or LINUX, and code, for the computing system 600. The operating system 614 may be multi-user, multiprocessing, multitasking, multithreading, real-time, and the like. For example, during runtime, the operating system 614 is running and the code for the computing system 600 is executed by the processor(s) 602.

The computer system 600 may include a data storage 616, which may include non-volatile data storage. The data storage 616 stores any data used or generated by the computer system 600.

The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, by at least one computing device, a plurality of algorithmic visualizations for a dataset;
generating, by one or more processors of the at least one computing device, a matrix based upon a plurality of visualization matrices, wherein each visualization matrix of the plurality of visualization matrices corresponds with an algorithmic visualization of the plurality of algorithmic visualizations;
generating, by the one or more processors, a synthetic matrix by randomly shuffling a plurality of values in each column of the matrix;
training, by the one or more processors, a random forest classifier to distinguish shuffled data of the synthetic matrix from unshuffled data of the matrix;
generating, by the one or more processors, an ensemble visualization graph, wherein the ensemble visualization graph comprises a plurality of samples and each sample of the plurality of samples is associated with a leaf node of a plurality of leaf nodes across all trees of a random forest;
extracting, by the one or more processors, from the ensemble visualization graph, an embedding vector corresponding to each sample of the plurality of samples to generate an embedding matrix; and
generating, by the one or more processors, based upon the embedding matrix, a data visualization harmonizing the plurality of algorithmic visualizations.

2. The computer-implemented method of claim 1, wherein each algorithmic visualization of the plurality of algorithmic visualizations is a multi-dimensional algorithmic visualization.

3. The computer-implemented method of claim 1, wherein each algorithmic visualization of the plurality of algorithmic visualizations is a two-dimensional algorithmic visualization.

4. The computer-implemented method of claim 1, wherein each algorithmic visualization of the plurality of algorithmic visualizations is a three-dimensional algorithmic visualization.

5. The computer-implemented method of claim 1, wherein generating the matrix based upon the plurality of visualization matrices comprises generating or constructing the matrix by juxtaposing the plurality of visualization matrices.

6. The computer-implemented method of claim 1, wherein generating the ensemble visualization graph comprises connecting one or more samples of the plurality of samples to a respective leaf node of the plurality of leaf nodes across all trees of the random forest and discarding other nodes of each tree of the random forest.

7. The computer-implemented method of claim 6, further comprising removing, from the ensemble visualization graph, samples of the plurality of samples corresponding to the synthetic matrix.

8. The computer-implemented method of claim 1, wherein the plurality of algorithmic visualizations includes a uniform manifold approximation and projection visualization, a T-distributed stochastic neighbor embedding visualization, a potential of heat-diffusion for affinity-based trajectory embedding visualization, and/or principal component analysis visualization.

9. The computer-implemented method of claim 1, wherein the dataset is a single cell gene expression dataset.

10. A system comprising:
at least one memory storing instructions; and
at least one processor communicatively coupled with the at least one memory and configured to execute the instructions to cause the system to perform operations comprising:
receiving a plurality of algorithmic visualizations for a dataset;
generating a matrix based upon a plurality of visualization matrices, wherein each visualization matrix of the plurality of visualization matrices corresponds with an algorithmic visualization of the plurality of algorithmic visualizations;
generating a synthetic matrix by randomly shuffling a plurality of values in each column of the matrix;
training a random forest classifier to distinguish shuffled data of the synthetic matrix from unshuffled data of the matrix;
generating an ensemble visualization graph, wherein the ensemble visualization graph comprises a plurality of samples and each sample of the plurality of samples is associated with a leaf node of a plurality of leaf nodes across all trees of a random forest;
extracting, from the ensemble visualization graph, an embedding vector corresponding to each sample of the plurality of samples to generate an embedding matrix; and
generating, based upon the embedding matrix, a data visualization harmonizing the plurality of algorithmic visualizations.

11. The system of claim 10, wherein each algorithmic visualization of the plurality of algorithmic visualizations is a multi-dimensional algorithmic visualization.

12. The system of claim 10, wherein each algorithmic visualization of the plurality of algorithmic visualizations is a two-dimensional algorithmic visualization.

13. The system of claim 10, wherein each algorithmic visualization of the plurality of algorithmic visualizations is a three-dimensional algorithmic visualization.

14. The system of claim 10, wherein generating the matrix based upon the plurality of visualization matrices comprises generating or constructing the matrix by juxtaposing the plurality of visualization matrices.

15. The system of claim 10, wherein generating the ensemble visualization graph comprises connecting one or more samples of the plurality of samples to a respective leaf node of the plurality of leaf nodes across all trees of the random forest and discarding other nodes of each tree of the random forest.

16. The system of claim 15, wherein the operations further comprise removing, from the ensemble visualization graph, samples of the plurality of samples corresponding to the synthetic matrix.

17. The system of claim 10, wherein the plurality of algorithmic visualizations includes a uniform manifold approximation and projection visualization, a T-distributed stochastic neighbor embedding visualization, a potential of heat-diffusion for affinity-based trajectory embedding visualization, and/or principal component analysis visualization.

18. The system of claim 10, wherein the dataset is a single cell gene expression dataset.

19. A non-transitory computer-readable media (CRM) storing instructions thereon, which when executed by at least one processor of at least one computing device, cause to perform operations comprising:
receiving a plurality of algorithmic visualizations for a dataset;
generating a matrix based upon a plurality of visualization matrices, wherein each visualization matrix of the plurality of visualization matrices corresponds with an algorithmic visualization of the plurality of algorithmic visualizations;
generating a synthetic matrix by randomly shuffling a plurality of values in each column of the matrix;
training a random forest classifier to distinguish shuffled data of the synthetic matrix from unshuffled data of the matrix;
generating an ensemble visualization graph, wherein the ensemble visualization graph comprises a plurality of samples and each sample of the plurality of samples is associated with a leaf node of a plurality of leaf nodes across all trees of a random forest;
extracting, from the ensemble visualization graph, an embedding vector corresponding to each sample of the plurality of samples to generate an embedding matrix; and
generating, based upon the embedding matrix, a data visualization harmonizing the plurality of algorithmic visualizations.

20. The non-transitory CRM of claim 19, wherein:
generating the matrix based upon the plurality of visualization matrices comprises generating or constructing the matrix by juxtaposing the plurality of visualization matrices;
generating the ensemble visualization graph comprises connecting one or more samples of the plurality of samples to a respective leaf node of the plurality of leaf nodes across all trees of the random forest and discarding other nodes of each tree of the random forest;
each algorithmic visualization of the plurality of algorithmic visualizations is a multi-dimensional algorithmic visualization; and
the plurality of algorithmic visualizations includes a uniform manifold approximation and projection visualization, a T-distributed stochastic neighbor embedding visualization, a potential of heat-diffusion for affinity-based trajectory embedding visualization, and/or principal component analysis visualization.
